(19) United States
(12) Patent Application Publication
(10) Pub. No.: US 2025/0321018 A1
(43) Pub. Date: Oct. 16, 2025

(54) THERMOSTAT CLIMATE CONTROL MANAGEMENT

(71) Applicant: Generac Power Systems, Inc., Waukesha, WI (US)

(72) Inventors: Joshua Stangel, Oak Creek, WI (US); Nicholas J. Schmidling, Hubertus, WI (US); Michael Sinclair, Toronto (CA); Brent Laurence, Toronto (CA); Matthew Kowalski, Milwaukee, WI (US)

(73) Assignee: Generac Power Systems, Inc., Waukesha, WI (US)

(21) Appl. No.: 19/177,025

(22) Filed: Apr. 11, 2025

Related U.S. Application Data
(60) Provisional application No. 63/634,827, filed on Apr. 16, 2024.

(51) Int. Cl. F24F 11/63; F24F 140/00; H02J 3/14

(52) U.S. Cl. CPC F24F 11/63; H02J 3/14; F24F 2140/00

(57) ABSTRACT

Systems and methods are provided for managing electrical devices for use with a generator, and, particularly, climate control (e.g., Heating, Ventilation, and Air Conditioning (HVAC)) management systems and methods for use with a generator. A climate control energy management system or controller, such as a thermostat, can monitor the frequency of the source power to determine if power is supplied by a generator or a utility. If the thermostat determines that the source of energy is generator power, the controller can determine whether the generator is reaching full capacity. If the generator is reaching full capacity or is at full capacity, the thermostat can reduce the climate control load or otherwise adjust the operation of climate control system.

### CROSS-REFERENCE TO RELATED APPLICATION(S)

This application claims the benefit of and priority to U.S. Application No. 63/634,827, filed on Apr. 16, 2024, titled THERMOSTAT CLIMATE CONTROL MANAGEMENT, the disclosure of which is hereby incorporated by reference in its entirety.

### BACKGROUND

Most residential buildings and commercial buildings utilize electrical power received from a utility company. Ideally, utility companies will provide uninterrupted or infrequently interrupted power to their customers at proper voltage levels and line frequency. However, the electrical generation systems of the utility are susceptible to disruptions caused by factors such as heightened or otherwise variable demand, equipment failures, adverse weather conditions (e.g., high winds, precipitation, ice, fires, and lightning), and the like, potentially resulting in intermittent power outages. The duration of power outages can vary based on the cause and the severity of the problem, impeding the operation of electrical devices that are powered via energy the utility supplies.

Electrical generators can be used as backup sources of energy, such as during a power outage from a utility. The electrical generators can operate in a stand-by mode, where electrical power provided by a primary source, such as from a utility, may be monitored. If the power provided by the primary source utility fails or otherwise ceases, the electrical generator can automatically start operating to generate electrical power and prevent the total loss of available electrical power.

An electrical generator may have a generation capacity less than the power demands the generator is responsible for, such as the typical power usage of a residential building. Sizing the electrical generator to have a capacity to meet power demands can be prohibitively expensive and impractical and may not be possible due to regulations.

### SUMMARY

In general terms, this disclosure is directed to managing a generator, and, particularly, climate control (e.g., Heating, Ventilation, and Air Conditioning (HVAC)) management systems and methods for use with a generator. A climate control energy management system or controller, such as a thermostat, can monitor the frequency of the source power to determine if the power supplied by a generator or a utility. If the thermostat determines that the source of energy is generator power, the thermostat may determine whether the generator is reaching full capacity. If the generator is reaching full capacity or is at full capacity, the thermostat can reduce the climate control load.

In some embodiments, and by non-limiting example, a method of managing a climate control system for use with a generator system comprises, by a thermostat: monitoring a frequency of electrical power supplied to the climate control system; determining that the generator system is supplying power based on the frequency; and in response to determining the generator system is supplying power, shedding at least a portion of an electrical load of the climate control system to operate at a percentage of full power. The method can further comprise determining to increase the percentage of full power based on the frequency; and in response to determining to increase the percentage of full power, increasing the percentage of full power. In example implementations, determining to increase the percentage of full power based on the frequency comprises determining a magnitude of frequency dither is at or below a frequency dither threshold for a period. In further example implementations, determining to increase the percentage of full power based on the frequency comprises: sampling the frequency, wherein sampling the frequency comprises sampling a sample amount; determining all of the samples of the frequency have a magnitude of frequency dither at or below a first frequency dither threshold; and determining a second portion of the samples of the frequency have the magnitude of frequency dither at or below a second frequency dither threshold. In additional example implementations, determining to increase the percentage of full power based on the frequency comprises determining the generator system is no longer supplying power based on the frequency.

In some examples, shedding at least the portion of the electrical load of the climate control system comprises adjusting temperature settings of the thermostat. In example implementations, determining the generator system is supplying power based on the frequency comprises determining the frequency is any one of (i) below a minimum threshold frequency for a first period, or (ii) below an extreme threshold frequency for a second period. In some embodiments, monitoring the frequency comprises determining an amount of zero-crossings during a plurality of subperiod. Determining the generator system is supplying power based on the frequency can comprise determining a subperiod of the plurality of subperiods are below a minimum threshold amount of zero-crossings; evaluating one or more previous subperiods of the subperiod to determine whether any of the previous subperiods are below an extreme frequency threshold; and evaluating subsequent subperiods of the subperiod to determine whether the subsequent periods are below the minimum threshold.

In another aspect, a method of managing power supply of a climate control system from a generator system comprises: monitoring a frequency of electrical power supplied to the climate control system; determining that the generator system is supplying power based on the frequency; in response to determining the generator system is supplying power, shedding a portion of an electrical load of the climate control system to operate at a percentage of full power; delaying increasing the percentage of full power for a period; and after the period, increasing the percentage of full power. In some embodiments, the method further comprises determining the frequency is below a threshold after increasing the percentage of full power; in response to determining the frequency is below the threshold, shedding a second portion of the electrical load to operate at a second percentage of full power; delaying monitoring the frequency for a second period; after the second period, determining the frequency is above a second threshold; and in response to determining the frequency is above the second threshold, again increasing the percentage of full power.

In certain embodiments, increasing the percentage of full power comprises increasing the percentage of full power by a second percentage; determining the frequency is above a threshold; and in response to determining the frequency is above the threshold, increasing the percentage of full power by a third percentage. In example implementations, increasing the percentage of full power further comprises again determining the frequency is above the threshold; and in response to determining the frequency is again above the threshold, again increasing the percentage of full power by a fourth percentage. In additional example implementations, increasing the percentage of full power further comprises determining the frequency is below the threshold; and in response to determining the frequency is below the threshold, reducing the percentage of full power by a fourth percentage.

In some embodiments, the portion of the electrical load is a full electrical load, and the percentage of full power is zero percent. In certain embodiments, at least the portion of the electrical load of the climate control system comprises adjusting temperature settings of the thermostat.

In another aspect, of managing a climate control system for use with a generator system comprises: causing the climate control system to operate according to normal settings; monitoring a frequency of electrical power; determining that the generator system is supplying power based on the frequency; and in response to determining the generator system is supplying power, causing the climate control system to operate according to generator backup settings. In some embodiments, the method further comprises determining the generator system in no longer supplying power based on the frequency; and in response to determining the generator system is not supplying power, causing the climate control system to resume operating according to the normal settings. In other embodiments, the method further includes monitoring the operation of one or more electrical devices, wherein causing the climate control system to operate according to the generator backup settings is further based on the operation of the one or more electrical devices.

In some embodiments, the method further includes, in response to causing the climate control system to operate according to the generator backup settings, sending a notification to a user device indicating the climate control system is operating at the generator backup settings. In other embodiments, the method further comprises, in response to causing the climate control system to operate according to the generator backup settings, sending a notification to an operator device indicating the climate control system is operating at the generator backup settings. In additional embodiments, the method further includes, in response to causing the climate control system to operate according to the generator backup settings, displaying a notification on a display indicating the climate control system is operating at the generator backup settings. In yet other embodiments, the method further comprises determining the frequency indicates poor power quality; and causing the climate control system to stop operating.

In further embodiments, the method further comprises setting a priority of the climate control system and one or more electrical devices, wherein causing the climate control system to operate according to the generator backup settings is further based on the priority of the climate control system and the one or more electrical devices. In additional embodiments, the method can further include receiving a priority of the climate control system and one or more electrical devices, wherein causing the climate control system to operate according to the generator backup settings is further based on the priority of the climate control system and the one or more electrical devices. In example implementations, the method further includes receiving an updated priority of the climate control system and the one or more electrical devices.

In some embodiments, the method further includes detecting an occupancy state, wherein causing the climate control system to operate according to the generator backup settings is further based on the occupancy state. In example implementations, the method further includes determining the occupancy state indicates occupancy; and in response to the occupancy state indicating occupancy, causing an electrical device to operate at a lower power state before causing the climate control system to operate according to the generator backup settings. In further embodiments, the method further includes receiving an instruction to cause the climate control system to operate according to user instructions from a user device; and in response to receiving the instruction, causing the climate control system to operate according to the user instructions.

In yet another aspect, a system comprises a climate control system; and a thermostat operable to: monitor a frequency of electrical power supplied to the climate control system; determine that a generator system is supplying power based on the frequency; and in response to determining the generator system is supplying power, adjust the operation of the climate control system. In some embodiments, to adjust the operation of the climate control system comprises to adjust temperature settings of the thermostat. In further embodiments, the thermostat is further operable to receive a user input indicating generator backup settings; and to adjust the operation of the climate control system comprises to adjust temperature settings of the thermostat to the generator backup settings.

In additional embodiments, to adjust the operation of the climate control system comprises to determine generator backup settings; and adjust temperature settings of the thermostat to the generator backup settings. In yet further example embodiments, the thermostat in further operable to: determine that the generator system in no longer supplying power based on the frequency; and in response to determining the generator system is not supplying power, cause the climate control system to resume operating according to normal settings. In additional embodiments, the thermostat is further operable to: monitor the operation of one or more electrical devices, wherein to adjust the operation of the climate control system is based on the operation of the one or more electrical devices.

In a further aspect, a system comprises a memory storage; and a processing unit coupled to the memory storage, wherein the processing unit is operative to perform operations comprising the method described in any of the embodiments above.

In another aspect, a thermostat comprises a memory storage; and a processing unit coupled to the memory storage, wherein the processing unit is operative to perform operations comprising the method described in any of the embodiments above.

In yet another aspect, a non-transitory computer-readable medium stores a set of instructions which when executed perform operations comprising the method described in any of the embodiments above.

### BRIEF DESCRIPTION OF THE DRAWINGS

FIG. 1 is a schematic view of an operating environment for managing a climate control system for use with a generator backup.

FIG. 2 is a schematic view of an example controller and climate control system of FIG. 1.

FIG. 3 is an illustration of an example controller of FIG. 1.

FIG. 4 is a block diagram of a first user interface of the example controller of FIG. 1.

FIG. 5 is a block diagram of a second user interface of the example controller of FIG. 1.

FIG. 6 is a block diagram of a third user interface of the example controller of FIG. 1.

FIG. 7 is a block diagram of a fourth user interface of the example controller of FIG. 1.

FIG. 8 is a block diagram of a fifth user interface of an example user device of FIG. 1.

FIG. 9 is a block diagram of a sixth user interface of an example user device of FIG. 1.

FIG. 10 is a block diagram of a seventh user interface of an example user device of FIG. 1.

FIG. 11 is a block diagram of an eighth user interface of an example user device of FIG. 1.

FIG. 12 is an illustration of an example residence.

FIG. 13 is a flowchart of an example method of managing a climate control system.

FIG. 14 is a flowchart of a second example method of managing a climate control system.

FIG. 15 is a flowchart of a third example method of managing a climate control system.

FIG. 16 is a flowchart of a fourth example method of managing a climate control system.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

An electrical generator may have a generation capacity less than the power demands the generator is responsible for, such as the typical power usage of a residential building. Sizing the electrical generator to have a capacity to meet power demands can be prohibitively expensive and impractical and may not be possible due to regulations. Therefore, electrical generators may be managed to strategically allocate the power the electrical generator can generate to prioritize the supply of power to certain devices while potentially not supplying power to other devices.

Systems and methods for managing a climate control system, such as a Heating, Ventilation, and Air Conditioning (HVAC) system and/or other systems for controlling temperature, humidity, air purity, etc., for use with a generator backup are described herein. The climate control system may be present in various operating environments including residential and commercial buildings. A controller, such as a thermostat, can control the operation of the climate control system.

Managing a climate control system for use with a generator backup can include the controller causing the climate control system to operate according to generator backup settings, including ceasing operation to shed the electrical load entirely or operating at a less power intensive mode to reduce the load by a percentage of the climate control system's full load during normal operation for example. The controller can cause the climate control system to operate at a lower power mode by instructing the climate control system to disable one or more climate control system components (e.g., heater, air conditioner, humidifier, dehumidifier, air purifier) or adjust when the climate control system operates or otherwise uses climate control system components. For example, the controller may adjust temperature settings for when a heating system or air conditioning system should operate, such as instructing or otherwise causing the climate control system to operate the heating system only if the interior temperature reaches four degrees less than the usual trigger temperature (e.g., heating only when sixty-four degrees Fahrenheit is reached instead of heating when sixty-eight degrees Fahrenheit is reached). A user can instruct or otherwise control the controller to configure the temperature increases and/or decreases when the generator backup is supplying power.

The controller can execute or otherwise implement an algorithm to determine whether the climate control system and/or other systems of operating environment are receiving power from a generator backup by monitoring the frequency of the received power. The controller can use the algorithm to determine that a generator backup is supplying power when the frequency drops. For example, a thermostat monitors frequency of the power via the wiring of the climate control system (e.g., via the common wire (C-wire)).

Once the controller determines that the frequency of power dropped and the generator backup is therefore supplying power, the controller can instruct or otherwise cause the climate control system to cease operation to shed the climate control system load or to operate at a lower power mode. For example, the controller may adjust temperature settings for a heating system or air conditioning system, adjust humidity settings for a humidifier or dehumidifier, adjust air quality settings for an air purification system, and/or the like. Additionally, the operation of certain components may be adjusted before others. A user may prefer their residence to maintain a comfortable temperature instead of a humidity and air quality level, so the controller may disable the operation of a humidifier, dehumidifier, and/or air purifier before adjusting operation of a heating system or air conditioning system.

The controller may also cause the climate control system to operate at a reduced power by applying a duty cycle of supplied electrical power to one or more of the climate control system components. Thus, one or more of the climate control system components may receive a power for a percentage of a period and not receive power for the remaining percentage of the period. Thus, the climate control system components may still operate for a shorter amount of time because of the duty cycle, thereby operating at a reduced power mode.

The controller can also cause the climate control system to reconnect at a lower power mode to operate at a reduced load or cause the climate control system to reconnect or otherwise resume operation at normal power to operate at a full load. The mode the climate control system resumes operating in can be based on the generator backup's capacity, the priority of the climate control system, whether power from another source (e.g., a utility) is restored, and/or the like. For example, the controller may not cause the climate control system to resume operation until the controller detects power from the other source is restored and the generator is no longer supplying power or can attempt to cause the climate control system to resume operation while the generator operates at a power level that the generator can accommodate.

In some embodiments, the controller delays causing the climate control system to resume operation. The controller may determine the delay settings, store the delay settings, and/or receive delay settings from a user. For example, the user can select a delay length (e.g., delay period) for the controller to wait before causing the climate control system to resume operation when the controller determines the generator backup is supplying power. The user can also select different delay lengths based on whether other managed loads are present in the system (e.g., an electric vehicle charger, refrigerator, television, sound system, washing machine, dryer, dish washer, etc.). The delay may be a minimum of five minutes in some examples. In some embodiments, the user can adjust the trigger temperature the heater and/or the air conditioner systems begin operating to reduce the power the climate control system will consume when the generator backup is operating. In yet other embodiments, the controller can set the climate control system in a lockout mode so the climate control system will not operate when the generator backup is operating. The user can optionally override the lockout mode to enable the climate control system to operate when the generator is operating.

The user can also change the delay or cause the climate control system to resume or cease operation when the generator backup is operating. For example, the thermostat monitors and displays the current home temperature and allows the user to adjust the reconnection delay and dynamically control the climate control system in consideration with other equipment the user desires to utilize while on backup power. The user can therefore dynamically control the climate control system to initiate or cease operation when the generator backup operates to maintain a desired temperature, humidity, air quality, and/or the like.

In some embodiments, the load shedding algorithm the controller uses to determine how to control the climate control system is or includes the methods and operations of the load shed systems and modules and/or controllers described in U.S. Pat. Nos. 10,069,331, 11,108,265, and 11,831,197, which are hereby incorporated by reference in their entirety. For example, the controller can use the algorithm to manage the reduction of power one or more loads consume, including the climate control system, without a user having to adjust the output power between load shedding events. The load shedding algorithm can also optimize the operation of the climate control system based on the size of the generator, allowing the climate control system to operate to meet user temperature and/or other climate preferences as closely as possible without overloading the generator and preventing other systems from operating. Thus, the systems and methods for managing a climate control system include determining when to cause the climate control system to shed its load or otherwise operate at a lower power mode and determine how and when the climate control system should reconnect to receive power.

In some embodiments, there are two different frequency thresholds before the controller causes the climate control system to cease operation—a minimum threshold and an extreme threshold. These thresholds define whether the generator system can handle the currently applied load and whether the climate control system will shed its load. In some examples, the minimum frequency threshold for sixty Hertz (Hz) generators is fifty-eight Hz, two Hz from nominal, and the extreme threshold is fifty Hz, ten Hz from nominal. In other examples, the minimum frequency threshold for sixty Hertz generators is 59.8 Hz. For fifty Hz generators, the minimum frequency threshold can be forty-eight Hz, two Hz from nominal, and the extreme threshold can be forty Hz, ten Hz from nominal.

In some embodiments, monitoring the power (i.e., monitoring the frequency) to determine when the climate control system should shed its load or otherwise operate at a lower power mode includes checking the power in an interval (e.g., every millisecond). If the voltage has gone from positive to negative, or negative to positive, since the last interval, a zero crossing is counted. Every ⅛th of a second, or 125 ms, the zero-crossing count can be collected and accumulated into a total zero-crossing count over the last four collections, accounting for a half-second of zero-crossings. This half-second zero-crossing count can be logged. Six contiguous half-second counts can be collected for the frequency evaluation.

If the most recent half-second zero crossing count is below the minimum frequency threshold, the climate control system and/or another monitoring system may check the previous half-second zero-crossing counts. If any of the previous half-second counts (e.g., the last six half-second counts) are below the extreme threshold, the climate control system will shed its. If the frequency remains below the minimum threshold for the next three seconds, the climate control system will shed its load. If the frequency recovers, or increases, or if the frequency rises above the minimum threshold over the next three seconds, the climate control system will not shed the load, and the controller will consider the decrease in frequency a false alarm.

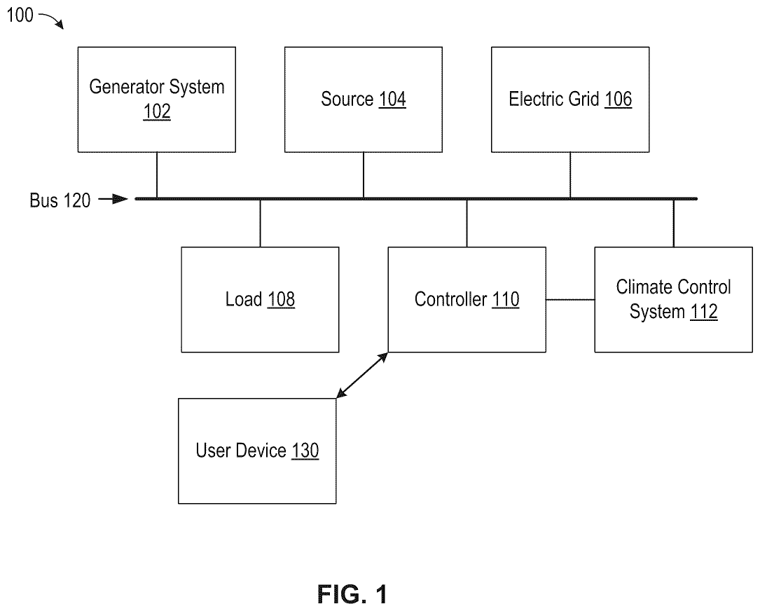

FIG. 1 is a schematic view of an operating environment 100 for managing a climate control system for use with a generator backup. The operating environment 100 includes a generator system 102, a source 104, an electric grid 106, a load 108, a controller 110, a climate control system 112, a bus 120, and a user device 130. The generator system 102, the source 104, the electric grid 106, the load 108, the controller 110, and the climate control system 112 can supply and/or receive electric power via the bus 120. The bus 120 can be an electric connection for a single-family home, an apartment complex, a commercial building, or some other building or complex. In additional embodiments, more or fewer systems may be connected to the bus 120 (e.g., multiple generator systems, multiple sources, multiple loads, etc.).

The generator system 102 may be a generator backup capable of generating and supplying power, such as when power from the electric grid 106 is stopped. The source 104 may be any system that generates and supplies power. For example, the source 104 may be a photovoltaic system, a wind turbine, or some other system that generates power. The electric grid 106 may be associated with a utility and supply power. The load 108 may be any system that receives power, such as an appliance, an electronic, and the like.

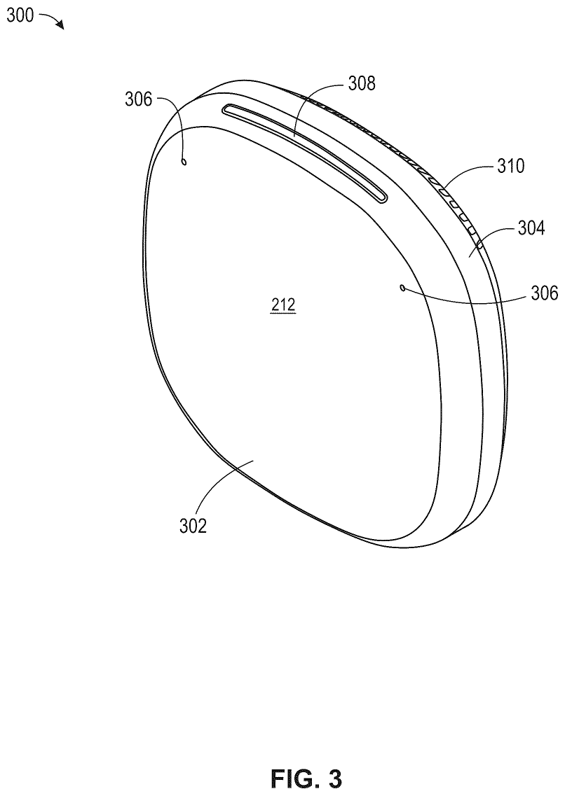

The controller 110 controls the operation of the climate control system 112. In certain embodiments, the controller 110 is a thermostat, for example as will be illustrated in FIG. 3 and described below. The thermostat may be a smart thermostat capable of connecting to wireless networks and controlling the climate control system 112 and/or other systems automatically. The controller 110 can cause the climate control system 112 to shed its load or otherwise operate in a lower power mode and reconnect or otherwise operate in a higher power mode in response to whether the generator system 102 is supplying power via the bus 120 or is not supplying power.

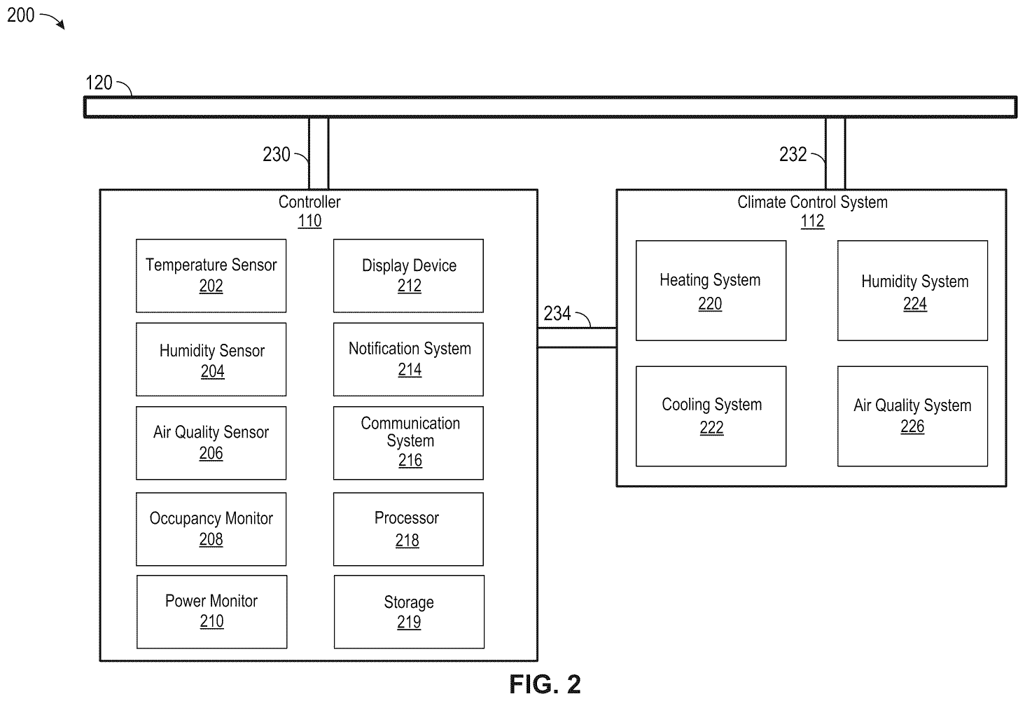

The user device 130 is any device (e.g., a smart phone, a tablet, a personal computer) that a user may operate. The user may use the user device 130 to control the operation of the climate control system 112 by communicating with the controller 110. For example, the user device 130 can send temperatures to the controller 110 that the controller 110 uses to determine when to initiate operation of the climate control system 112. The controller 110 can include components for monitoring when the generator system 102 is operating to determine when to adjust operation of components and for reconnecting to power in some embodiments, described in more detail with respect to FIG. 2. In other embodiments, the controller 110 can communicate with separate monitoring systems to determine when to adjust operation of components and for reconnecting power.

FIG. 2 is a schematic view 200 of the controller 110 and the climate control system 112. The controller 110 includes a temperature sensor 202, a humidity sensor 204, an air quality sensor 206, an occupancy monitor 208, a power monitor 210, a display device 212, a notification system 214, a communication system 216, a processor 218, and a storage 219. The controller 110 can include more or fewer components in other examples, such as other sensors, less sensors, and/or the like. The climate control system 112 includes a heating system 220, a cooling system 222, a humidity system 224, and an air quality system 226. The climate control system 112 can include more or fewer systems and/or components in other examples. In some embodiments, the climate control system 112 comprises multi-stage heating and cooling equipment.

The controller 110 connects to the bus 120 via a first connection 230, and the climate control system 112 connects to the bus 120 via a second connection 232. In some examples, the controller 110 may not directly connect to the bus 120 and may receive power via the third connection 234. The controller 110 and the climate control system 112 connect via a third connection 234. The third connection 234 may include multiple wires, such as a common wire (C-wire), one or more R-wires for power (e.g., Rc and Rh wires), a G-wire for ventilation such as fans, a Y-wire for cooling, a W-wire for heating, an O-wire for a heat pump, and/or the like. The third connection 234 may also include one or more relays that include circuitry for the detection of the multiple wires. The controller 110 can monitor the frequency of the power to identify when the generator system 102 is operating via the C-wire.

The temperature sensor 202 senses the temperature of the environment (e.g., the operating environment 100 or a structure present in the operating environment 100), the humidity sensor 204 senses the humidity of the environment, and the air quality sensor 206 senses the air quality of the environment (e.g., air quality index). The occupancy monitor 208 includes one or more sensors to enable the controller 110 to determine whether the environment is occupied. For example, the occupancy monitor 208 includes one or more motion sensors, one or more microphones, one or more device location trackers to identify the location of the user device 130, and/or the like. The controller 110 can additionally connect to external sensors, including external temperature sensors, humidity sensors, air quality sensors, and occupancy sensors. The controller 110 communicate with the external sensors via the communication system 216.

The power monitor 210 can monitor the characteristics of the power the climate control system 112 receives via the bus 120. For example, the power monitor 210 monitors the frequency of the power the climate control system 112 receives to determine whether the generator system 102 is operating. The power monitor 210 can identify when the frequency of the power drops to determine whether the generator system 102 is operating based on the frequency drop. The controller 110 may then cause the climate control system 112 to cease operating or operate in a low power mode at least for a delay or until power from the electric grid 106 is restored and the generator system 102 stops supplying power. In some embodiments, the power monitor 210 monitors the frequency of the power using the C-wire as described above.

The display device 212 is a device for displaying information and/or receiving input. The display device 212 is a touch screen in some embodiments. The display device 212 can display various user interfaces that can include information and different inputs for adjusting the operation of the climate control system 112, adjusting operating settings, adjusting the priority of the climate control system 112, and the like. Operating settings can include the temperatures, humidity, and/or air quality to keep the environment at (i.e., when to cause the heating system 220, the cooling system 222, the humidity system 224, and the air quality system 226 to operate) during normal conditions when the environment is occupied, during normal conditions when the environment is not occupied, during backup generator operating conditions when the environment is occupied, and during backup generator operating conditions when the environment is not occupied. The operating settings can also vary based on the time (e.g., less heating and cooling at night). The operating settings can also include the priority of the climate control system 112, indicating whether the climate control system 112 should adjust or cease operation for a load 108 or continue operating while the load 108 adjusts or ceases operation, delay preferences for when to reconnect the climate control system 112, and/or the like.

The notification system 214 includes one or more components for notifying a user. For example, the notification system 214 can include a speaker system to generate tones for notifications, a light system with one or more indicator lights to illuminate for notifications, and/or the like. The notification system 214 can indicate when the climate control system 112 is operating normally and when the climate control system 112 is operating under specified conditions when the generator system 102 is operating.

The controller 110 uses the communication system 216 to wirelessly communicate with other devices, including the user device 130, external sensors, and/or the like. The communication system 216 may enable the controller 110 to connect to and communicate with other devices using short-range wireless technology, cellular communication technology, local area networking, infrared technology, radio, and/or the like. The controller 110 can send information to the user device 130 via the communication system 216, such as the state of the environment, the operating state of the climate control system 112, the operating settings, the state of the generator system 102, and the like. The controller 110 can also receive instructions from the user device 130, such as a mode for the climate control system 112 to operate in, adjustments to operating settings, a command to initiate operation or stop the climate control systems, notification that the environment is occupied or is not occupied, and the like.

The processor 218 can process instructions and data to enable the controller 110 to perform actions, such as determining the state of the environment using the sensors, determining whether the environment is occupied using the occupancy monitor 208, determining whether the frequency of the power drops using the power monitor 210, displaying information and receiving input via the display device 212, displaying or otherwise causing notifications using the notification system 214, and communicating with devices using the communication system 216. The storage 219 can store instructions for the processor 218 to execute, data such as the state of the environment, the date and time, operating settings, and the like.

The heating system 220 is one or more components to heat the environment, such as a furnace, boiler, forced air system, radiator, a heat pump, etc. The cooling system 222 is one or more components to cool the environment, such as a central air conditioner, ductless mini-split air conditioners, window air conditioners, geothermal air conditioners, evaporative cooling air conditioners, etc. The humidity system 224 is one or more components to humidify or dehumidify the environment. The air quality system 226 is one or more components to ventilate and/or filter air.

The controller 110 can control the operation of the components of the climate control system 112, such as the heating system 220, the cooling system 222, the humidity system 224, and the air quality system 226, based on the state of the environment operating settings (e.g., temperature settings, humidity settings, air quality settings, settings based on occupancy state, settings based on time of day), and whether the generator system 102 is operating. The controller 110 can determine the state of the environment using the temperature sensor 202, the humidity sensor 204, and the air quality sensor 206.

When the controller 110 detects that the generator system 102 is operating using the power monitor 210, the controller 110 can determine whether to cause the climate control system 112 to adjust operation or stop operating. The controller 110 can determine how to adjust the operation of the climate control system 112 (e.g., adjusting the temperatures that will trigger the heating system 220 or the cooling system 222, disabling the humidity system 224 and/or the air quality system 226) or to stop the climate control system 112 based on the magnitude of the frequency drop that indicates the generator system 102, because the magnitude of the frequency drop may indicate whether the generator system 102 is supplying sufficient power to one or more loads 108 that a user wants operating and to the climate control system 112.

The determination to adjust or stop operation of the climate control system 112 can also be based on the priority of the climate control system 112. For example, if the climate control system 112 has priority over a load 108 that is consuming power, the controller 110 may wait to adjust operation of the climate control system 112 until the load 108 with the lower priority adjusts or ceases operation. The controller 110 can then determine if the climate control system 112 should adjust or cease operating based on determining if the generator system 102 can supply sufficient power without having to supply power to the lower priority load 108. If there are no lower priority loads 108 that can adjust operation or cease operating and the generator system 102 is not supplying sufficient power, the controller 110 can then adjust or stop operation of the climate control system 112.

The priority of the climate control system 112 may be based on occupancy state, current inside temperature, current outside temperature, difference between current inside temperature and desired inside temperature, relative humidity, air quality, and/or the like. For example, the climate control system 112 may be assigned a higher priority for cooling a building when the outside temperature is ninety degrees Fahrenheit than when the outside temperature is seventy degrees Fahrenheit. In some embodiments, components of the climate control system 112 have individually assigned priorities. For example, cooling system 222 can be assigned a higher priority than the humidity system 224 and the air quality system 226 to indicate that the humidity system 224 and the air quality system 226 should be disabled or set to lower power modes before the operation of the cooling system 222 is adjusted. Thus, the humidity system 224, the air quality system 226, and the load 108 may be disabled or otherwise operate at lower power to enable the cooling system 222 to maintain normal operation. The controller 110 can determine the priorities of the climate control system 112 and other devices based on various factors (e.g., occupancy state, current inside temperature, current outside temperature, difference between current inside temperature and desired inside temperature, relative humidity, air quality, preferences of which devices should remain operational, etc.), from inputs indicating the priorities (e.g., from a user device 130), and/or the like.

In some embodiments, when the controller 110 adjusts or stops operation of one or more components of the climate control system 112, the controller 110 may not attempt to reconnect the climate control system 112 or readjust operation to normal for a delay. The controller 110 may receive the delay from the user device 130 or as input via the display device 212, may determine the delay based on the priority assigned to the climate control system 112, or the like. For example, the storage 219 may store a look-up table containing different delay durations for each priority level. In other embodiments, the controller 110 may use a fixed delay duration and multiply the fixed delay duration by the priority level. For example, a fixed duration of five minutes may be used. If the priority level of the climate control system 112 is one (i.e., highest priority), the total delay duration is five minutes. If the priority level of the climate control system 112 is two, the total duration is ten minutes, and so on for lower priority levels.

When the controller 110 causes the climate control system 112 to resume operating or readjust to normal operation, the controller 110 may monitor the power to determine whether the frequency drops again, indicating the generator system 102 is still running and cannot accommodate the climate control system 112. The controller 110 can then cause the climate control system 112 to revert to the lower power mode or stop operating for the delay or until the controller 110 determines the generator system 102 stops operating.

According to some embodiments, the controller 110 determines whether the frequency of the is at least within two Hz of the nominal frequency. If the frequency is more than two hertz below the nominal frequency, the controller 110 determines that the generator system 102 cannot accommodate the climate control system 112 or otherwise is not operating normally and resets the delay before attempting to reconnect the climate control system 112. The controller 110 can wait until it detects either that one of the power supplies (e.g., the electric grid 106 or the generator system 102) are operating within normal operating parameters. Once the controller 110 detects that one of the power supplies is operating within normal operating parameters, the controller 110 can reconnect or otherwise adjust operation of the climate control system 112.

In some embodiments, adjusting operation of the climate control system 112 is based on the available components. For example, the climate control system 112 may include two heating system 220 devices, a heat pump and a fossil fuel furnace. When generator system 102 operation is detected, the controller 110 may cause the heating system 220 to disable or operate the heat pump at lower power and operate the fossil fuel furnace even if the heating system 220 would otherwise indicate that the heat pump should be used. Thus, the heating system 220 can operate at a lower power mode. Other climate control system 112 components may also have alternative energy components that can be used while lowering the power consumption of the climate control system 112. The controller 110 may also cause the climate control system 112 to reduce the staging level in multi-stage equipment from a more energy-intensive stage to a lower-intensive stage to lower the power usage of the climate control system 112.

FIG. 3 is an illustration of the controller 110. The illustrated controller 110 is a thermostat 300. The thermostat 300 includes the display device 212, a touch screen in the illustrated example, on the front face 302. The front face 302 is attached to the housing 304. The thermostat 300 also includes sensors 306, which can include the temperature sensor 202, the humidity sensor 204, the air quality sensor 206, and the occupancy monitor 208. The thermostat 300 also includes a light system 308 and a speaker system 310. The notification system 214 can generate notifications using the light system 308 and/or the speaker system 310.

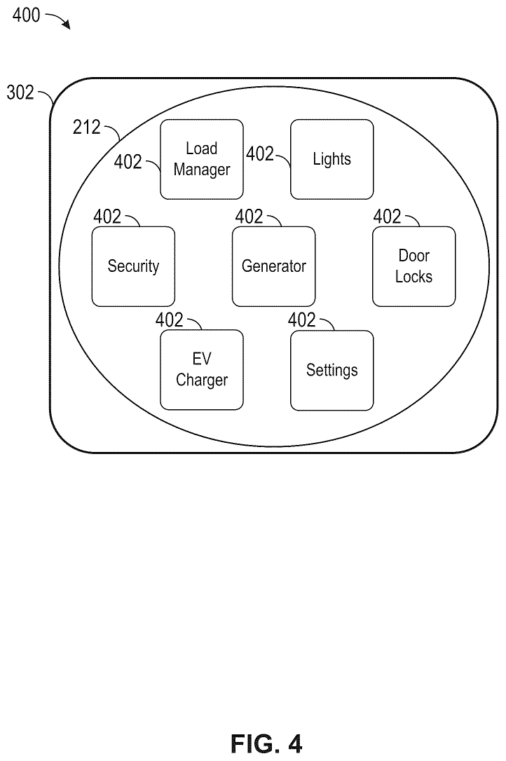

FIG. 4 is a block diagram of a first user interface 400 of the controller 110. The first user interface 400 is displayed on the display device 212 for user review and includes application icons 402 for user interaction. The application icons 402 are selectable to display additional user interfaces. For example, a user can select one of the application icons 402 to display settings, to display the state of the environment, to display inputs to adjust temperature options during normal operation and when the generator system 102 is operating, to display inputs to adjust other systems in the environment, and the like.

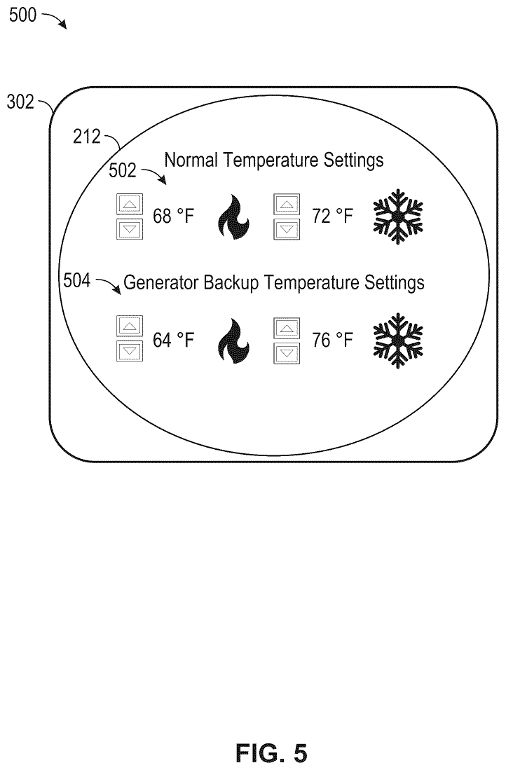

FIG. 5 is a block diagram of a second user interface 500 of the controller 110. The second user interface 500 is displayed on the display device 212 and includes normal temperature settings inputs 502 and generator backup temperature settings inputs 504. The user can select the temperatures the climate control system 112 should maintain during normal operation with the normal temperature settings inputs 502 and select the temperatures the climate control system 112 should maintain when the generator system 102 is operating with the generator backup temperature settings inputs 504. As illustrated, the climate control system 112 will operate in a lower power mode when the generator system 102 is operating because the heating system 220 will only begin operation when the temperature is sixty-four degrees Fahrenheit instead of sixty-eight degrees Fahrenheit and the cooling system 222 will only being operation when the temperature is seventy-six degrees Fahrenheit instead of seventy-two degrees Fahrenheit. The controller 110 can display similar user interfaces for selecting normal humidity settings, backup generator humidity settings, normal air quality settings, backup generator air quality settings, and/or the like. In certain embodiments, the controller 110 further displays inputs for other normal setting and generator backup settings, such as an order of devices to stop operating when the generator backup is operating (e.g., disable the humidity system 224, air quality system 226, and the like before disabling the cooling system 222).

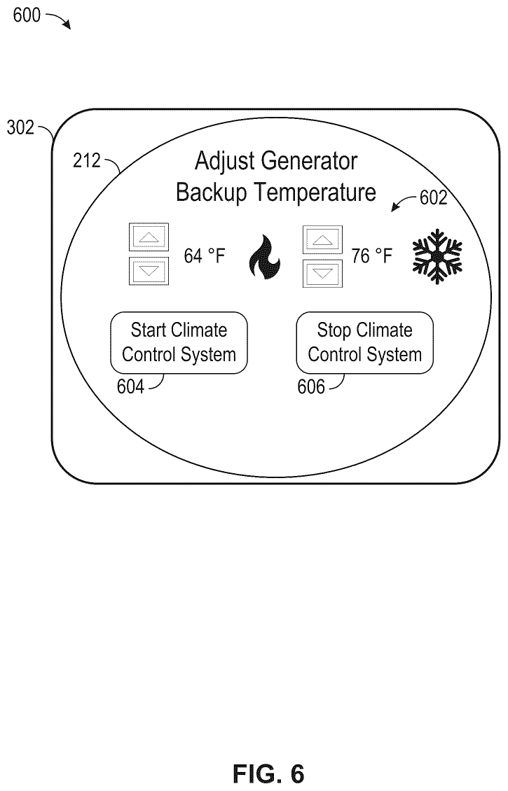

FIG. 6 is a block diagram of a third user interface 600 of the controller 110. The third user interface 600 is displayed on the display device 212 and includes generator backup temperature settings adjustment inputs 602, a start climate control system input 604, and a stop climate control system input 606. A user can adjust the temperature settings of the climate control system 112 while the generator system 102 is operating via the generator backup temperature settings adjustment inputs 602. In some examples, the controller 110 automatically determines the temperature settings the climate control system 112 should operate at to be able to operate while the generator system 102 is supplying power. The controller 110 may determine relative setbacks (e.g., changes to the normal temperature settings such as five degrees higher before enabling cooling) or determine temperature setpoints independently of normal temperature settings. The user can override or manually start the climate control system 112 using the start climate control system input 604. The controller 110 may then ignore the operation of the generator system 102 and attempt to operate the climate control system 112 without evaluating the frequency of the power. The user can manually stop the climate control system 112 using the stop climate control system input 606. The controller 110 can display similar user interfaces for adjusting the humidity settings and air quality settings, inputs for starting and stopping the humidity system 224 and the air quality system 226, and/or the like.

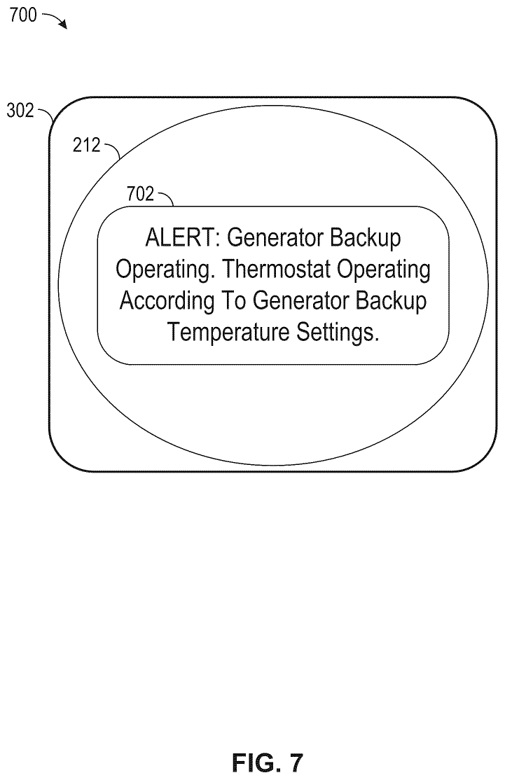

FIG. 7 is a block diagram of a fourth user interface 700 of the controller 110. The fourth user interface 700 is displayed on the display device 212 and includes a generator alert 702. The generator alert 702 notifies the user that the generator system 102 has begun operating and the climate control system 112 is either not operating or operating at a lower power mode (e.g., operating according to backup generator temperature settings). The thermostat 300 may additionally use the light system 308 and the speaker system 310 to notify the user.

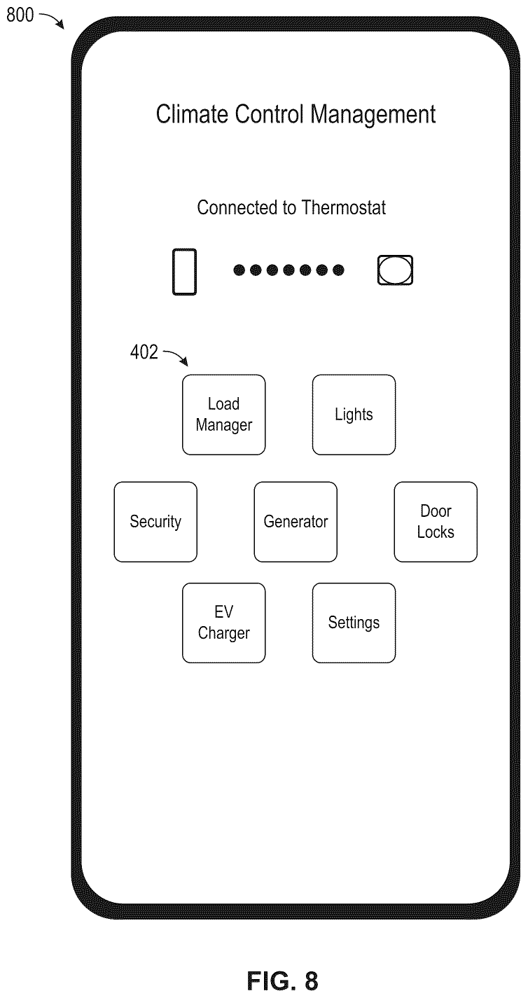

FIG. 8 is a block diagram of a fifth user interface 800 of the user device 130. The fifth user interface 800 includes the application icons 402. Thus, a user can access the various user interfaces on the user device 130 by interacting with the application icons 402.

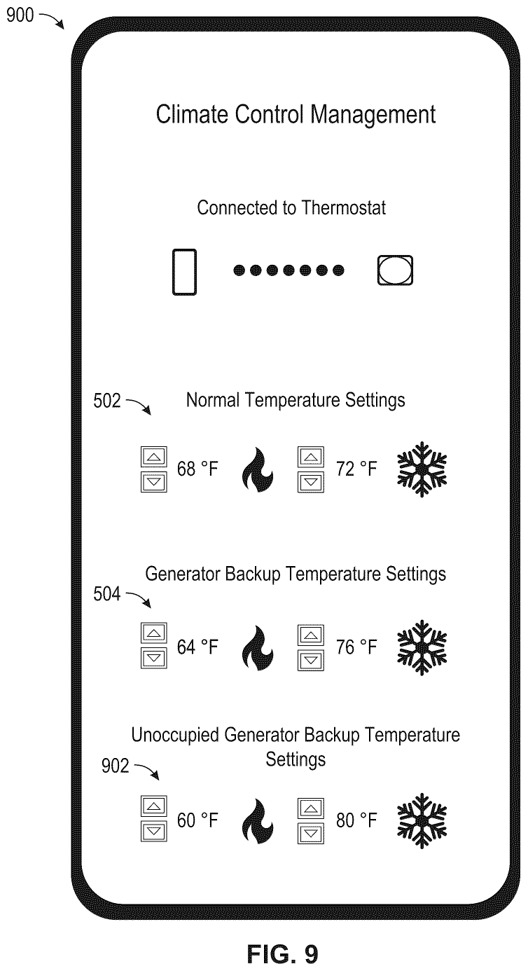

FIG. 9 is a block diagram of a sixth user interface 900 of the user device 130. The sixth user interface 900 includes the normal temperature settings inputs 502, the generator backup temperature settings inputs 504, and unoccupied generator backup temperature settings inputs 902. Thus, a user can adjust the temperature settings via the user device 130 using the normal temperature settings inputs 502 and the generator backup temperature settings inputs 504. The user can additionally select temperature settings when the environment is unoccupied using the unoccupied generator backup temperature settings inputs 902. The thermostat 300 may also display the unoccupied generator backup temperature settings inputs 902 in a user interface for user selection.

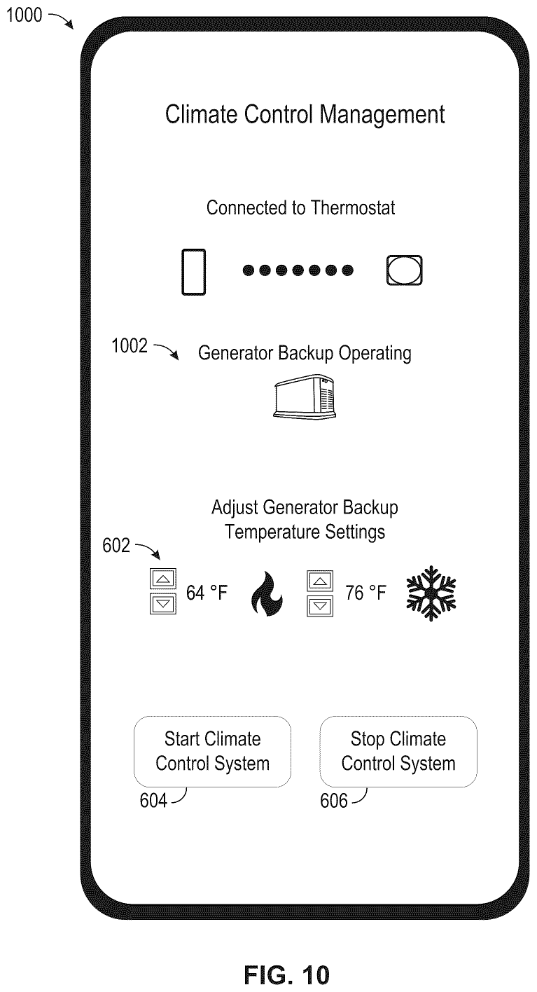

FIG. 10 is a block diagram of a seventh user interface 1000 of the user device 130. The seventh user interface 1000 includes the generator backup temperature settings adjustment inputs 602, the start climate control system input 604, the stop climate control system input 606, and a generator status indicator 1002. Therefore, a user, via the user device 130, can adjust temperature settings using the generator backup temperature settings adjustment inputs 602, start the climate control system 112 using the start climate control system input 604, and stop the climate control system 112 using the stop climate control system input 606. The generator status indicator 1002 indicates whether the generator system 102 is operating or not.

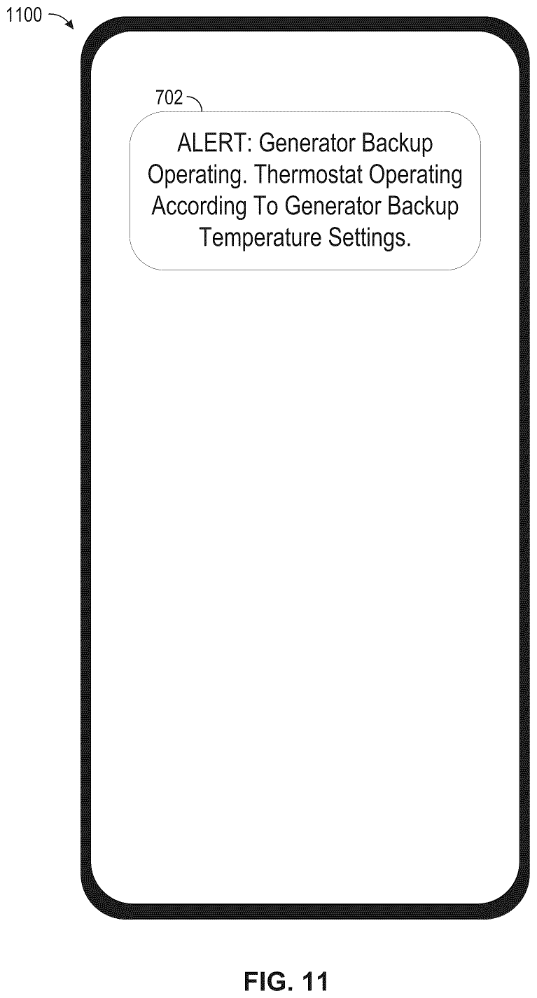

FIG. 11 is a block diagram of an eighth user interface 1100 of the user device 130. The eighth user interface 1100 includes the generator alert 702. Thus, a user can be notified that the generator system 102 is operating via the user device 130.

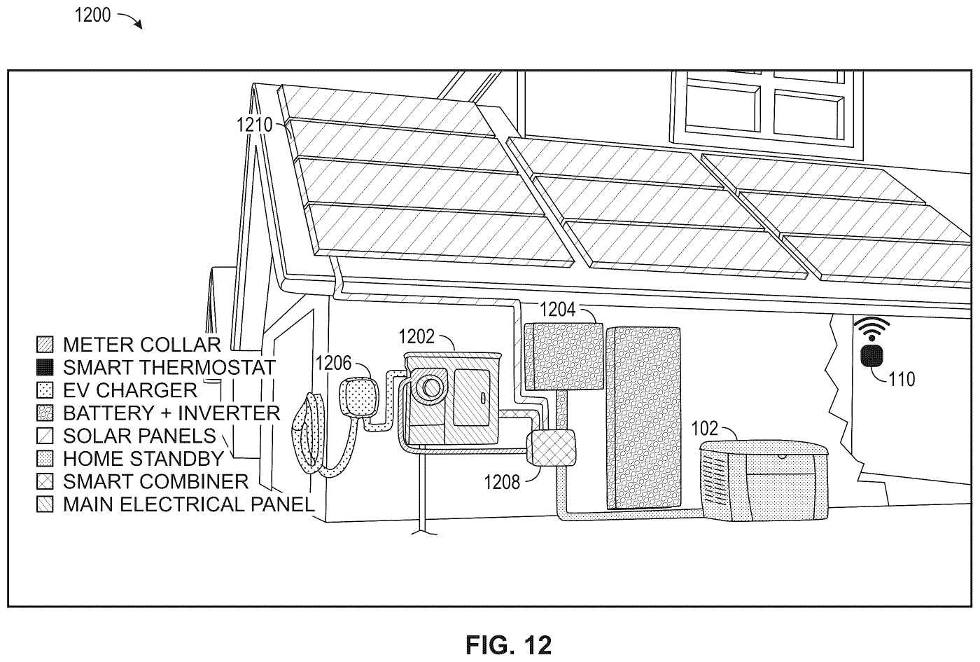

FIG. 12 is an illustration of a residence 1200. The residence 1200 includes the generator system 102, the controller 110, a main electrical panel 1202, a battery and inverter 1204, an electric vehicle charger 1206, a combiner 1208, and solar panels 1210. The main electrical panel 1202 can be an electrical breaker box that connects devices to the electric grid 106. The battery and inverter 1204 can store and provide electrical power to devices of the residence 1200. Thus, the batter and inverter 1204 acts as a source 104 when providing electrical power and acts as a load 108 when consuming electrical power for storage. The electric vehicle charger 1206 can act as a load 108 when connected to an electric vehicle for charging. The combiner 1208 includes connections and combines inputs from the devices of the residence 1200. For example, the combiner 1208 can be a junction for the output of the solar panels 1210. The solar panels 1210 can act as a source 104 when generating electrical power.

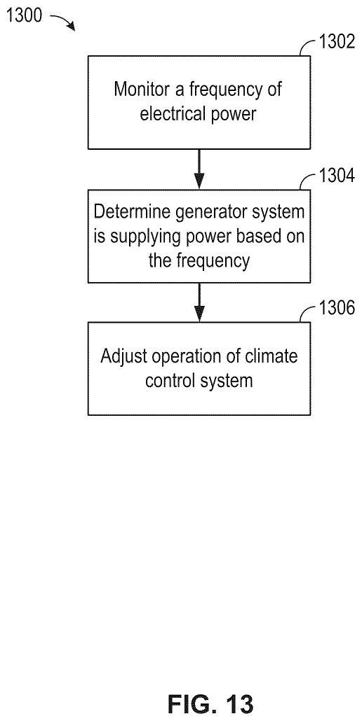

FIG. 13 is a flowchart of a method 1300 of managing the climate control system 112. The method 1300 begins at operation 1302. In operation 1302, a frequency of electrical power is monitored. For example, the controller 110 monitors the frequency of electrical power supplied via the bus 120 using the connection to the climate control system 112. The controller 110 may monitor the frequency according to the methods described above, such as determining an amount of zero-crossings during a plurality of subperiods, determining a subperiod of the plurality of subperiods are below a minimum threshold amount of zero-crossings, evaluating one or more previous subperiods of the subperiod to determine whether any of the previous subperiods are below an extreme frequency threshold, and evaluating subsequent subperiods of the subperiod to determine whether the subsequent periods are below the minimum threshold.

In operation 1304, it is determined that the generator system is supplying power based on the frequency. The controller 110 can determine the generator system is supplying power based on the frequency being below a minimum threshold frequency for a first period or below an extreme threshold frequency for a second period (i.e., shorter than the first period). For example, the controller 110 determines the generator system 102 is supplying power because the frequency of the power drops below two Hz of the nominal frequency for a period. The controller 110 may determine the generator system 102 is supplying power according to the methods described above.

In operation 1306, operation of the climate control system is adjusted. For example, the controller 110 adjusts the operation of the climate control system 112. The controller 110 may cause the climate control system 112 to cease operation, only operate components that do not consume electrical power, operate at a lower power mode (e.g., use generator backup temperature settings or otherwise adjust temperature settings, disable or reduce power consumption of one or more components), and/or the like. The controller 110 may determine how to adjust operation of the climate control system 112 according to the methods described above.

In some examples, the controller 110 may disable or reduce power consumption of climate control system 112 components differently or otherwise individually. For example, humidity changes and air quality typically occur slowly and/or affect the comfort of the environment less relative to temperature changes, so the controller 110 may disable or reduce power consumption of the humidity system 224 and/or the air quality system 226 before the heating system 220 or the cooling system 222. Additionally, certain parts can consume a high proportion of electricity, such as fan operation. These high power consumption parts can be disabled while allowing the climate control system 112 components to maintain operation at a lower power.

The controller 110 can also adjust operation of the climate control system 112 by applying duty-cycling to one or more of the climate control system 112 components. The controller 110 can also change set points and settings to new set points and settings to reduce power consumption. The controller 110 can also apply a relative setback (e.g., reduce a temperature the set point by 4 degrees from the current set point). The setback can be a fixed amount or a user-defined amount (e.g., the thermostat 300 can enable customers to configure the setback based upon their own comfort preferences). The setback may be shared in common between different power-saving modes (such as unoccupied mode, during a demand response event, when generator is producing power, etc.). Changing the setback may not necessarily achieve a direct change in the load of the climate control system 112, which can be impacted by other factors such as the current inside and outside temperature, the insulation value of the premise, and/or the like. For example, a home may have an occupied cooling set point of seventy degrees Fahrenheit, an unoccupied cooling set point of eighty degrees Fahrenheit, and a generator backup temperature set point of seventy-six degrees Fahrenheit when occupied and eighty degrees Fahrenheit when unoccupied. Thus, the inside temperature can reach eighty degrees Fahrenheit when unoccupied. If the user returns, the occupied set points then control. If the generator system 102 still operates, the cooling system 222 will still operate to cool the premise to seventy-six degrees Fahrenheit to reach the occupied generator backup setpoint. While there is no immediate load shedding, the occupied backup generator set point is a lower power mode because the cooling system 222 will not cool the premise to seventy degrees Fahrenheit to reach the occupied cooling set point. Some customers may have two or three-stage climate control system 112 equipment, which can heat/cool faster than single stage equipment based upon the conditioning needs.

The controller 110 can continue to monitor the frequency while the climate control system 112 operates at the percentage of full power, and the controller 110 can determine to increase the percentage of full power based on the frequency. For example, the controller 110 may determine that the generator system 102 can handle the increased percentage of full power, a source 104 is producing power to enable the climate control system 112 to operate at the increased percentage of full power, the electric grid 106 has resumed supplying power, the generator system 102 has stopped operating, and/or the like. The controller 110 can then instruct the climate control system 112 to increase the percentage of full power (e.g., enable one or more components, switch from generator backup settings to normal settings, etc.). The controller 110 can determine to increase the percentage of full power by determining a magnitude of frequency dither is at or below a frequency dither threshold for a period. The controller 110 can also determine to increase the percentage of full power by sampling the frequency, wherein sampling the frequency comprises sampling a sample amount, determining all of the samples of the frequency have a magnitude of frequency dither at or below a first frequency dither threshold, and determining a second portion of the samples of the frequency have the magnitude of frequency dither at or below a second frequency dither threshold.

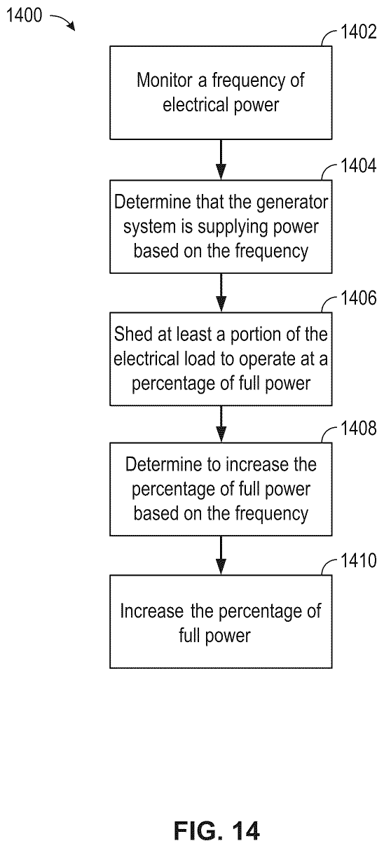

FIG. 14 is a flowchart of a second example method 1400 of managing the climate control system 112. The method 1400 begins at operation 1402, and a frequency of electrical power is monitored. For example, the controller 110 monitors the frequency of electrical power supplied via the bus 120 using the connection to the climate control system 112. The controller 110 may monitor the frequency according to the methods described above.

In operation 1404, it is determined that the generator system is supplying power based on the frequency. For example, the controller 110 determines the generator system 102 is supplying power because the frequency of the power drops below two Hz of the nominal frequency for a period. The controller 110 may determine the generator system 102 is supplying power according to the methods described above.

In operation 1406 portion of the electrical load is shed to operate at a percentage of full power. For example, the controller 110 causes the climate control system 112 to operate at a lower power mode (e.g., generator backup temperature settings) or stop operating to shed at least a portion of the electrical load to operate at a percentage of full power in response to determining the generator system 102 is supplying power. The controller 110 may determine that the climate control system 112 should operate at a lower power mode or stop operating based on the priority, the magnitude of the frequency drop compared to the expected frequency, and/or the like.

In operation 1408, it is determined to increase the percentage of full power based on the frequency. For example, the controller 110 determines the generator system 102 is no longer supplying power and the electric grid 106 is supplying power on the frequency of the power. In another example, the determines the generator system 102 can accommodate the climate control system 112 operating at an increased percentage of full power (e.g., normal settings).

In operation 1410, the percentage of full power is increased. For example, the controller 110 causes the climate control system 112 to increase the percentage of full power (e.g., normal settings such as normal temperature settings, reenabling systems, etc.) in response to determining to increase the percentage of full power in operation 1410. In an example, the controller 110 determines the climate control system 112 can operate at one hundred percent of full power.

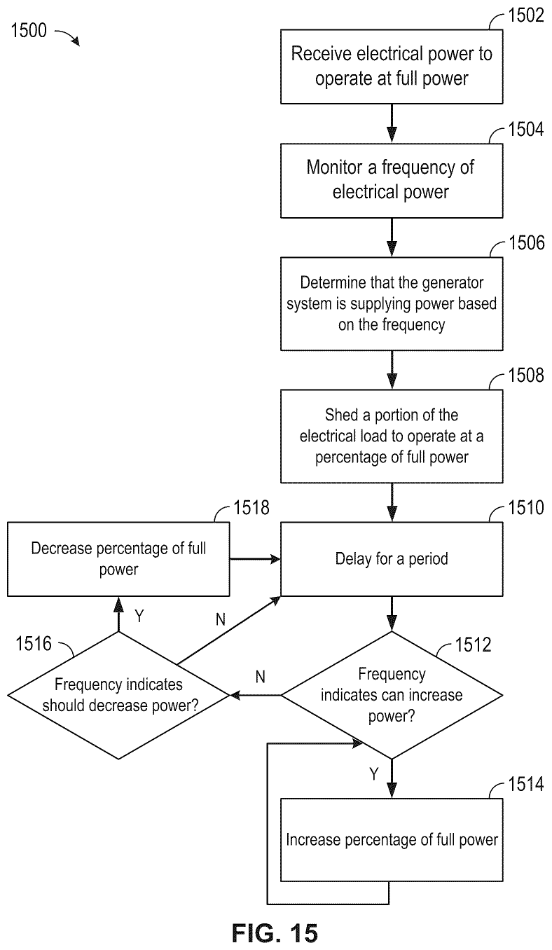

FIG. 15 is a flowchart of a third example method 1500 of managing a climate control system 112. The method 1500 begins at operation 1502. In operation 1502, electrical power is received to operate at full power. For example, the electric grid 106 supplies power to the bus 120, and the climate control system 112 operates at full power using the power the electric grid 106 supplies.

In operation 1504, a frequency of electrical power is monitored. For example, the controller 110 monitors the frequency of electrical power supplied via the bus 120. The controller 110 may monitor the frequency according to the methods described above.

In operation 1506, it is determined that the generator system is supplying power based on the frequency. For example, the controller 110 determines the generator system 102 is supplying power because the frequency of the power drops below two Hz of the nominal frequency for a period. The controller 110 may determine the generator system 102 is supplying power according to the methods described above.

In operation 1508, a portion of the electrical load is shed to operate at a percentage of full power. For example, the controller 110 causes the climate control system 112 to operate at a lower power mode or stop operating to shed at least a portion of the electrical load to operate at a percentage of full power in response to determining the generator system 102 is supplying power. In some examples, the controller 110 causes the climate control system 112 to stop operating. In other examples, the controller 110 causes the climate control system 112 to operate at a low percentage of full power (e.g., operate a single system at low power) to evaluate the impact of the climate control system 112 operating while the generator system 102 is operating.

In operation 1510, adjustment of the climate control system 112 is delayed for a period. For example, the controller 110 does not adjust the percentage of full power the climate control system 112 is operating at for the delay period. The delay period may be five minutes in some examples. The delay period may be based on the priority of the climate control system 112 as described above. For example, when the climate control system 112 has the highest priority (i.e., the user desires the climate control system 112 to operate more than other systems), the delay period may be five minutes. When the climate control system 112 has the second highest priority, the delay period may be ten minutes. When the climate control system 112 has the third highest priority, the delay period may be fifteen minutes, and subsequent priorities may each include an additional five minutes of delay.

In decision 1512, it is determined whether the frequency indicates the climate control system 112 can increase power. For example, the controller 110 monitors the frequency of the power and determines whether the climate control system 112 can increase the percentage of full power the climate control system 112 is operating at. If the controller 110 determines the climate control system 112 can increase the percentage of full power in decision 1512, the method 1500 proceeds to operation 1514. In operation 1514, the percentage of full power increases. For example, the controller 110 can cause the climate control system 112 to increase the percentage of full power (e.g., enable systems, adjust operating settings to higher preference bands). The method 1500 may then continue to decision 1512 again, and the controller 110 may determine if the frequency indicates the climate control system 112 can again increase the percentage of power.

If it is determined in decision 1516 that the frequency does not indicate the frequency indicates the climate control system 112 can increase power, the method 1500 may proceed to decision 1516. In decision 1516, it is determined if the frequency indicates that the climate control system 112 should decrease the percentage of full power (e.g., disable systems, increase the operating bands to lower or delay the time the systems will operate). If the frequency indicates that the climate control system 112 should decrease full power, the method proceeds to operation 1518. In operation 1518, the percentage of full power is decreased. For example, the controller 110 may cause the climate control system 112 to decrease the percentage of full power. The method 1500 may then proceed back to operation 1510 and delay for the period. The period may change during subsequent returns to operation 1510.

If it is determined in decision 1516 that the climate control system 112 does not need to decrease power, the method 1500 may conclude and the climate control system 112 may operate at the final percentage of full power. Thus, the method 1500 may end at any percentage of full power that the generator system 102 can accommodate. The climate control system 112 may increase to operate at full power when the generator system 102 stops operating, and power is again received from the electric grid 106.

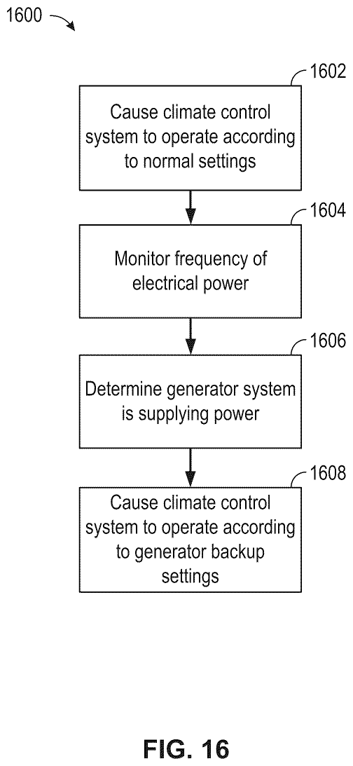

FIG. 16 is a flowchart of a fourth example method 1600 of managing a climate control system. The method 1600 begins at operation 1602, and a climate control system is caused to operate according to normal settings. For example, the controller 110 causes the climate control system 112 to operate according to normal settings, such as normal temperature settings, all components of the climate control system 112 enabled, etc. The normal temperature settings can be defined by a user (e.g., by user input via the thermostat 300), determined by the controller 110 (e.g., based on time of day, exterior temperature, weather forecast, etc.), and/or the like.

In operation 1604, the frequency of electrical power is monitored. For example, the controller 110 monitors the frequency of the electrical power supplied to the climate control system 112. The controller 110 can monitor the frequency according to the methods described above. In operation 1606, a generator system is determined to be supplying power. For example, the controller 110 determines the generator system 102 is operating based on the frequency. The controller 110 can determine the generator system 102 is operating based on the methods described above.

In operation 1608, the climate control system is caused to operate according to generator backup settings. For example, the controller 110 causes the climate control system 112 to operate according to generator backup settings, such as operating according to generator backup temperature settings (e.g., occupied or unoccupied generator backup temperature settings based on the occupancy), disabling or reducing power consumption of one or more components of the climate control system 112 and/or other systems (e.g., the load 108) according to an order for disabling or otherwise reducing the power consumption of components of the climate control system 112 and/or other systems, and/or the like. The controller 110 can determine the generator backup settings based on (i) user input (e.g., via the thermostat 300), (ii) the priority of the climate control system 112 and/or its components, (iii) time of day, exterior temperature, weather forecast, etc., and/or the like.

Referring to the above processes generally, it is noted that certain aspects may be performed in different orders. Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

The example embodiments described herein may be implemented using hardware, software, or a combination thereof and may be implemented in one or more computer systems or other processing systems. However, the manipulations performed by these example embodiments were often referred to in terms, such as entering, which are commonly associated with mental operations performed by a human operator. No such capability of a human operator is necessary in any of the operations described herein. Rather, the operations may be completely implemented with machine operations. Useful machines for performing the operation of the example embodiments presented herein include general purpose digital computers or similar devices.

From a hardware standpoint, a CPU typically includes one or more components, such as one or more microprocessors, for performing the arithmetic and/or logical operations required for program execution, and storage media, such as one or more memory cards (e.g., flash memory) for program and data storage, and a random-access memory, for temporary data and program instruction storage. From a software standpoint, a CPU typically includes software resident on a storage media (e.g., a memory card), which, when executed, directs the CPU in performing transmission and reception functions. The CPU software may run on an operating system stored on the storage media, such as, for example, UNIX or Windows, iOS, Linux, and the like, and can adhere to various protocols such as the Ethernet, ATM, TCP/IP protocols and/or other connection or connectionless protocols. As is well known in the art, CPUs can run different operating systems, and can contain different types of software, each type devoted to a different function, such as handling and managing data/information from a particular source or transforming data/information from one format into another format. It should thus be clear that the embodiments described herein are not to be construed as being limited for use with any particular type of server computer, and that any other suitable type of device for facilitating the exchange and storage of information may be employed instead.

A CPU may be a single CPU, or may include plural separate CPUs, wherein each is dedicated to a separate application, such as, for example, a data application, a voice application, and a video application. Software embodiments of the example embodiments presented herein may be provided as a computer program product, or software, which may include an article of manufacture on a machine accessible or non-transitory computer-readable medium (i.e., also referred to as “machine readable medium”) having instructions. The instructions on the machine accessible or machine-readable medium may be used to program a computer system or other electronic device. The machine-readable medium may include, but is not limited to, optical disks, CD-ROMs, and magneto-optical disks or other type of media/machine readable medium suitable for storing or transmitting electronic instructions. The techniques described herein are not limited to any particular software configuration. They may find applicability in any computing or processing environment. The terms “machine accessible medium”, “machine readable medium” and “computer-readable medium” used herein shall include any non-transitory medium that is capable of storing, encoding, or transmitting a sequence of instructions for execution by the machine (e.g., a CPU or other type of processing device) and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

While various example embodiments have been described above, it should be understood that they have been presented by way of example, and not limitation. It will be apparent to persons skilled in the relevant art(s) that various changes in form and detail can be made therein. Thus, the present invention should not be limited by any of the above-described example embodiments but should be defined only in accordance with the following claims and their equivalents.

What is claimed is:

1. A method comprising:
causing a climate control system to operate according to normal settings;
monitoring a frequency of electrical power supplied to the climate control system;
determining a generator system is supplying power based on the frequency; and
in response to determining the generator system is supplying power, causing the climate control system to operate according to generator backup settings.

2. The method of claim 1, wherein causing the climate control system to operate according to the generator backup settings comprises shedding at least a portion of an electrical load of the climate control system to operate at a percentage of full power.

3. The method of claim 2, further comprising:
determining to increase the percentage of full power based on the frequency; and
in response to determining to increase the percentage of full power, increasing the percentage of full power.

4. The method of claim 2, further comprising increasing the percentage of full power after a delay period.

5. The method of claim 1, further comprising:
determining the generator system in no longer supplying power based on the frequency; and
in response to determining the generator system is not supplying power, causing the climate control system to resume operating according to the normal settings.

6. The method of claim 1, further comprising:
monitoring operation of one or more electrical devices, wherein causing the climate control system to operate according to the generator backup settings is further based on the operation of the one or more electrical devices.

7. The method of claim 1, further comprising:
in response to causing the climate control system to operate according to the generator backup settings, sending a notification indicating the climate control system is operating at the generator backup settings to any one of (i) a user device, (ii) an operator device, (iii) a display configured to display the notification, or (iv) any combination of (i)-(iii).

8. The method of claim 1, wherein causing the climate control system to operate according to the generator backup settings comprises causing the climate control system to operate according to generator backup temperature settings.

9. The method of claim 1, further comprising:
determining a priority of the climate control system and one or more electrical devices, wherein causing the climate control system to operate according to the generator backup settings is further based on the priority of the climate control system and the one or more electrical devices.

10. The method of claim 1, further comprising:
detecting an occupancy state, wherein causing the climate control system to operate according to the generator backup settings is further based on the occupancy state.

11. The method of claim 10, further comprising:
determining the occupancy state indicates occupancy; and
in response to the occupancy state indicating occupancy, causing an electrical device to operate at a lower power state before causing the climate control system to operate according to the generator backup settings.

12. A system comprising:
a climate control system; and
a thermostat operable to:
cause the climate control system to operate according to normal settings;
monitor a frequency of electrical power supplied to the climate control system;
determine a generator system is supplying power based on the frequency; and
in response to determining the generator system is supplying power, cause the climate control system to operate according to generator backup settings.

13. The system of claim 12, wherein to cause the climate control system to operate according to the generator backup settings comprises to shed at least a portion of an electrical load of the climate control system.

14. The system of claim 12, wherein to cause the climate control system to operate according to the generator backup settings comprises to cause the climate control system to operate according to generator backup temperature settings.

15. The system of claim 12, wherein the thermostat in further operable to:
determine the generator system in no longer supplying power based on the frequency; and
in response to determining the generator system is not supplying power, cause the climate control system to operate according to the normal settings.

16. The system of claim 12, wherein the thermostat is further operable to:
monitor operation of one or more electrical devices, wherein to cause the climate control system to operate according to the generator backup settings comprises to adjust the operation of the climate control system based on the operation of the one or more electrical devices.

17. The system of claim 12, wherein the thermostat is further operable to:
determine a priority of the climate control system and one or more electrical devices, wherein causing the climate control system to operate according to the generator backup settings is further based on the priority of the climate control system and the one or more electrical devices.

18. A non-transitory computer-readable medium that stores a set of instructions which when executed perform operations comprising:
causing a climate control system to operate according to normal settings;
monitoring a frequency of electrical power supplied to the climate control system;
determining a generator system is supplying power based on the frequency; and
in response to determining the generator system is supplying power, causing the climate control system to operate according to generator backup settings.

19. The non-transitory computer-readable medium of claim 18, wherein causing the climate control system to operate according to the generator backup settings comprises shedding at least a portion of an electrical load of the climate control system to operate at a percentage of full power.

20. The non-transitory computer-readable medium of claim 18, wherein the set of instructions which when executed perform further operations comprising:
determining the generator system in no longer supplying power based on the frequency; and
in response to determining the generator system is not supplying power, causing the climate control system to resume operating according to the normal settings.
